(19) United States
(12) Patent Application Publication
(10) Pub. No.: US 2024/0428573 A1
(43) Pub. Date: Dec. 26, 2024

(54) Training a Classifier Model Relating to a Concept and Image Ratings Provided by a User

(71) Applicant: Google LLC, Mountain View, CA (US)

(72) Inventors: Ariel Fuxman, Redwood City, CA (US); Alexander Kenji Hata, Mountain View, CA (US); Edward Benjamin Vendrow, Redwood City, CA (US); Otilia Stretcu, Fremont, CA (US); Wenlei Zhou, Sunnyvale, CA (US); Krishnamurthy Viswanathan, Sunnyvale, CA (US); Aditya Avinash, Santa Clara, CA (US); Gabriel Berger, Cupertino, CA (US); Andrew Ames Bunner, Belmont, CA (US); Javier Alejandro Rey, San Mateo, CA (US); Wei Qiao, Santa Clara, CA (US); Yintao Liu, Union City, CA (US); Guanzhong Wang, Los Angeles, CA (US); Thomas Nathan Denby, Santa Monica, CA (US); Mehmet Nejat Tek, Redwood City, CA (US); Neil Gordon Alldrin, Campbell, CA (US); Enming Luo, Mountain View, CA (US); Chun-Ta Lu, Sunnyvale, CA (US)

(21) Appl. No.: 18/341,218

(22) Filed: Jun. 26, 2023

(51) Int. Cl. G06V 10/778; G06V 10/764; G06V 10/774; G06V 10/82; G06V 10/94

(52) U.S. Cl. CPC G06V 10/7788; G06V 10/764; G06V 10/7753; G06V 10/82; G06V 10/945

(57) ABSTRACT

A computer-implemented method includes receiving an input from a user relating to a concept, automatically obtaining a first set of images from an unlabeled dataset of images based on the input, and obtaining a first rating via the user for each image from the first set of images. The method further includes training a classifier model relating to the concept based on the first set of images rated by the user, automatically obtaining a second set of images from the unlabeled dataset of images based on the classifier model trained based on the first set of images, and obtaining a second rating via the user for each image from the second set of images. The classifier model relating to the concept is retrained based on the first set of images rated by the user and the second set of images rated by the user to obtain an updated classifier model.

### FIELD

The disclosure relates to a classifier model. More particularly, the disclosure relates to a classifier model that is trained based on ratings obtained from a user who provides an input relating to a concept.

### BACKGROUND

Involving humans in a training process has a long history in crowdsourcing, in developmental robotics, and even in computer vision, including recently in the field of large language modeling. However, these methods are primarily focused on improving model behavior. In other words, human-in-the-loop training according to existing methods is intended to leverage human feedback or interactions to make a model designed by others better.

Existing works describe automating the process of large-scale annotation by having users provide a single positive example and asking the crowd to determine whether other images are similar to it. For subjective concepts, particularly those with multiple visual modes, a single image may be insufficient to convey the meaning of the concept to the crowd.

Other works attempt to circumvent large-scale crowd labeling through the use of expert-designed labeling functions to automatically annotate a large, unlabeled dataset.

Personalization is an existing topic in building classification, detection, and image synthesis, however these methods are often devoid of real user interactions and test their resultant models on standard vision datasets.

Few-shot properties present in vision-language models (e.g., found in CLIP and ALIGN), illustrate it is possible to bootstrap classifiers with language descriptions. Besides functioning as a baseline, good representations have shown to similarly bootstrap active learning. However, few-shot learning has limited capabilities, especially for subjective concepts where a single language description or a single prototype is unlikely to capture the variance in the concept. Therefore, iterative approaches like active learning provide an appropriate formalism to maximize information about the concept while minimizing labels. Active learning methods derive their name by “actively” asking users to annotate data which the model currently finds most uncertain, or believes is most representative of the unlabeled set, or both. Unfortunately, most active learning methods are computationally intensive and take too long for real-world and real-time applications, reducing their utility. Methods to speed up active learning limit the search for informative data points, use low-performing proxy models for data selection, or use heuristics.

### SUMMARY

Aspects and advantages of embodiments of the disclosure will be set forth in part in the following description, or can be learned from the description, or can be learned through practice of the embodiments.

One example aspect of the disclosure is directed to a computer-implemented method for training a classifier model. The method includes receiving, by a computing system, an input from a user relating to a concept; automatically obtaining, by the computing system, a first set of images from an unlabeled dataset of images based on the input; obtaining, by the computing system, a first rating via the user for each image from the first set of images; training, by the computing system, a classifier model relating to the concept based on the first set of images rated by the user; automatically obtaining, by the computing system, a second set of images from the unlabeled dataset of images based on the classifier model trained based on the first set of images; obtaining, by the computing system, a second rating via the user for each image from the second set of images; and retraining, by the computing system, the classifier model relating to the concept based on the first set of images rated by the user and the second set of images rated by the user to obtain an updated classifier model.

In some implementations, the input comprises a plurality of text phrases.

In some implementations, the plurality of text phrases includes at least one positive textual description relating to the concept and at least one negative textual description relating to the concept.

In some implementations, the method further includes providing a rating tool to obtain the first rating and the second rating.

In some implementations, the rating tool comprises a user interface which displays each image from among the first set of images and the second set of images, and the user interface includes user interface elements which are selectable to indicate whether an image is a positive image corresponding to the concept or a negative image that does not correspond to the concept.

In some implementations, the classifier model is a binary classifier model.

In some implementations, the first rating is a binary rating indicating whether an image from the first set of images is a positive image corresponding to the concept or a negative image that does not correspond to the concept.

In some implementations, obtaining the first set of images from the unlabeled dataset of images based on the input comprises: co-embedding the unlabeled dataset of images and the input into a same space, and performing a nearest-neighbor search to retrieve the first set of images from among the unlabeled dataset of images to obtain images which are nearest to each text embedding.

In some implementations, the method further includes automatically obtaining, by the computing system, a third set of images from the unlabeled dataset of images based on the updated classifier model trained based on the first set of images and the second set of images; obtaining, by the computing system, a third rating via a plurality of users other than the user for each image from the third set of images; and retraining, by the computing system, the updated classifier model relating to the concept based on the first set of images rated by the user, the second set of images rated by the user, and the third set of images rated by the plurality of users, to obtain a further updated classifier model.

In some implementations, a number of the third set of images is greater than a number of the first set of images and greater than a number of the second set of images.

In some implementations, retraining, by the computing system, the updated classifier model relating to the concept comprises weighting a rating obtained via the user higher than ratings obtained via the plurality of users.

In some implementations, the method further includes providing a first rating tool to obtain the first rating and the second rating from the user and providing a second rating tool to obtain the third rating from the user.

In some implementations, the first rating tool comprises a first user interface which is configured to display each image from among the first set of images and the second set of images, the first user interface including user interface elements which are selectable to indicate whether an image from among the first set of images and the second set of images is a positive image corresponding to the concept or a negative image that does not correspond to the concept, and the second rating tool comprises a second user interface which is configured to display each image from among the third set of images, the second user interface including information providing an explanation relating to the concept for the plurality of users and user interface elements which are selectable to indicate whether an image from among the third set of images is a positive image corresponding to the concept or a negative image that does not correspond to the concept.

In some implementations, training the classifier model relating to the concept based on the first set of images rated by the user comprises: implementing one or more pretrained models to train a neural network using image embeddings provided by the one or more pretrained models.

Another example aspect of the disclosure is directed to a computing system for training a classifier model. The computing system includes one or more processors; and one or more non-transitory computer-readable media that store instructions that, when executed by the one or more processors, cause the computing system to perform operations, the operations comprising: receiving an input from a user relating to a concept; automatically obtaining a first set of images from an unlabeled dataset of images based on the input; obtaining a first rating via the user for each image from the first set of images; training a classifier model relating to the concept based on the first set of images rated by the user; automatically obtaining a second set of images from the unlabeled dataset of images based on the classifier model trained based on the first set of images; obtaining a second rating via the user for each image from the second set of images; and retraining the classifier model relating to the concept based on the first set of images rated by the user and the second set of images rated by the user to obtain an updated classifier model.

In some implementations, the input comprises a plurality of text phrases, the plurality of text phrases including at least one positive textual description relating to the concept and at least one negative textual description relating to the concept.

In some implementations, the classifier model is a binary classifier model, and the first rating is a binary rating indicating whether an image from the first set of images is a positive image corresponding to the concept or a negative image that does not correspond to the concept.

In some implementations, the operations further comprise: automatically obtaining a third set of images from the unlabeled dataset of images based on the updated classifier model trained based on the first set of images and the second set of images; obtaining a third rating via a plurality of users other than the user for each image from the third set of images; and retraining the updated classifier model relating to the concept based on the first set of images rated by the user, the second set of images rated by the user, and the third set of images rated by the plurality of users, to obtain a further updated classifier model.

In some implementations, a number of the third set of images is greater than a number of the first set of images and greater than a number of the second set of images, and retraining the updated classifier model relating to the concept comprises weighting a rating obtained via the user higher than ratings obtained via the plurality of users.

Other aspects of the disclosure are directed to various systems, apparatuses, non-transitory computer-readable media, user interfaces, and electronic devices. In one or more example embodiments, a computer-readable medium (e.g., a non-transitory computer-readable medium) which stores instructions that are executable by one or more processors of a computing system or computing device is provided. In some implementations the computer-readable medium stores instructions which may include instructions to cause the one or more processors to perform one or more operations of any of the methods described herein (e.g., operations of the computing system or of the computing device). The computer-readable medium may store additional instructions to execute other aspects of the computing system or of the computing device and corresponding methods of operation, as described herein.

For example, an aspect of the disclosure is directed to one or more non-transitory computer-readable media that collectively store instructions that, when executed by one or more processors, cause the one or more processors to perform operations, the operations comprising: receiving an input from a user relating to a concept; automatically obtaining a first set of images from an unlabeled dataset of images based on the input; obtaining a first rating via the user for each image from the first set of images; training a classifier model relating to the concept based on the first set of images rated by the user; automatically obtaining a second set of images from the unlabeled dataset of images based on the classifier model trained based on the first set of images; obtaining a second rating via the user for each image from the second set of images; and retraining the classifier model relating to the concept based on the first set of images rated by the user and the second set of images rated by the user to obtain an updated classifier model

These and other features, aspects, and advantages of various embodiments of the disclosure will become better understood with reference to the following description and appended claims. The accompanying drawings, which are incorporated in and constitute a part of this specification, illustrate example embodiments of the disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended drawings, in which:

FIG. 1A depicts a block diagram of an example computing system that performs various tasks using a machine-learned model, according to example embodiments of the disclosure.

FIG. 1B depicts a block diagram of an example computing device that performs various tasks using a machine-learned model, according to example embodiments of the disclosure.

FIG. 1C depicts a block diagram of an example computing device that performs various tasks using a machine-learned model, according to example embodiments of the disclosure.

FIG. 2 depicts a flow chart diagram of an example method for training an example machine-learned model, according to example embodiments of the disclosure.

FIGS. 3A-3B depict example graphical user interface screens for training an example machine-learned model, according to example embodiments of the disclosure.

FIG. 4 depicts a flow chart diagram of an example computer-implemented method for training an example machine-learned model, according to example embodiments of the disclosure.

FIG. 5 depicts a flow chart diagram of an example computer-implemented method for training an example machine-learned model, according to example embodiments of the disclosure.

FIG. 6 depicts an example graphical user interface screen for crowd raters to label images, according to example embodiments of the disclosure.

FIG. 7 depicts a graph illustrating the trained classifier model performance against a zero-shot baseline approach, according to example embodiments of the disclosure.

FIGS. 8A through 8C depicts graphs illustrating the trained classifier model performance based on user ratings against a classifier model trained based on crowd ratings, for different degrees of concept difficulty, according to example embodiments of the disclosure.

FIGS. 9A through 9C depict graphs illustrating the trained classifier model performance based on user ratings combined with crowd user ratings against classifier models trained based on user ratings or crowd ratings, according to example embodiments of the disclosure.

Reference numerals that are repeated across plural drawings are intended to identify the same features in various implementations.

### DETAILED DESCRIPTION

### Overview

Reference now will be made to embodiments of the disclosure, one or more examples of which are illustrated in the drawings, wherein like reference characters across drawings are intended to denote like features in various implementations. Each example is provided by way of explanation of the disclosure and is not intended to limit the disclosure.

Terms used herein are used to describe the example embodiments and are not intended to limit and/or restrict the disclosure. The singular forms “a,” “an” and “the” are intended to include the plural forms as well, unless the context clearly indicates otherwise. In this disclosure, terms such as “including”, “having”, “comprising”, and the like are used to specify features, numbers, steps, operations, elements, components, or combinations thereof, but do not preclude the presence or addition of one or more of the features, elements, steps, operations, elements, components, or combinations thereof.

It will be understood that, although the terms first, second, third, etc., may be used herein to describe various elements, the elements are not limited by these terms. Instead, these terms are used to distinguish one element from another element. For example, without departing from the scope of the disclosure, a first element may be termed as a second element, and a second element may be termed as a first element.

It will be understood that when an element is referred to as being “connected” to another element, the expression encompasses an example of a direct connection or direct coupling, as well as a connection or coupling with one or more other elements interposed therebetween.

The term “and/or” includes a combination of a plurality of related listed items or any item of the plurality of related listed items. For example, the scope of the expression or phrase “A and/or B” includes the item “A”, the item “B”, and the combination of items “A and B”.

In addition, the scope of the expression or phrase “at least one of A or B” is intended to include all of the following: (1) at least one of A, (2) at least one of B, and (3) at least one of A and at least one of B. Likewise, the scope of the expression or phrase “at least one of A, B, or C” is intended to include all of the following: (1) at least one of A, (2) at least one of B, (3) at least one of C, (4) at least one of A and at least one of B, (5) at least one of A and at least one of C, (6) at least one of B and at least one of C, and (7) at least one of A, at least one of B, and at least one of C.

According to current methods in computer vision, image classifiers generally learn from labels provided by a majority vote of crowd workers who annotate a set of categories that are pre-defined by researchers. An algorithm then trains on this aggregated ground truth, learning to predict labels that represent the crowd's majoritarian consensus.

While crowdsourcing has served the vision community well on many objective tasks (e.g., identifying objective concepts like identifying an animal as a “zebra”, “tiger”, etc.), it now falters on tasks where there is substantial subjectivity. Everyday people want to scale their own decision-making on concepts others may find difficult to emulate. For example, a sushi chef might covet a classifier to source gourmet tuna for inspiration. Majority vote by crowd workers may not converge to the same definition of what makes a tuna dish “gourmet” as would be understood by a professional chef.

Aspects of the disclosure are directed to user-centric approaches for developing real-world classifiers for subjective concepts. According to examples of the disclosure, a computing system may obtain an input from a user (e.g., a domain expert) to define a concept (e.g., a subjective concept) for training a classifier model. In some implementations, the classifier model can be developed by the computing system providing an interactive interface (e.g., a graphical user interface) such that users who are not machine learning experts can easily provide information to define a subjective decision boundary (e.g., by the user indicating positive and negative examples of the concept). According to examples of the disclosure, the computing system may be configured to train the classifier model without the user sifting through and annotating thousands of training instances that are typical for most image classification datasets. For example, ImageNet annotated over 160 million images to arrive at their final 14 million dataset version.

The computing system described herein provides an agile process by which a user can turn any visual concept into a computer vision model (e.g., a personal, subject vision model) through a real-time user-in-the-loop process which can also include an interactive guide during the training process, thereby minimizing the time and effort required to obtain a model.

For example, the computing system may receive an input relating to a concept (e.g., a single language description of their concept such as “gourmet tuna”) and leverage aspects of existing vision-language foundation models to train the classifier model. In some implementations, the computing system may be configured to leverage state of the art image-text co-embeddings for fast image retrieval and model training. For example, the computing system may be configured to implement active learning to identify instances that, if labeled, would maximally improve classifier performance. The computing system is configured to surface these few instances to the user, who is only asked to identify which of these instances are positive, which is a task that non-machine learning experts are capable of performing. This process may be performed iteratively with more active learning operations until the user is satisfied with the classifier model's performance.

Examples of the disclosure utilize a user-centric approach in which the computing system is configured to empower users to develop models that reflect their needs, rather than utilizing the user simply to improve a model designed by others.

Examples of the disclosure are directed to training a classification model by utilizing real users and by focusing on real-world sized datasets and on new, subjective concepts. Examples of the disclosure described herein demonstrate that a few minutes of annotation by users (e.g., domain experts) can lead to sizable gains over zero-shot classifiers. The computing systems described herein further show that performing model updates and ranking images on cached co-embedding features is a scalable and effective way to conduct active learning.

The disclosure provides numerous technical effects and benefits. For example, in some implementations, the classifier model may be trained and created in real-time by a user in less than thirty minutes (and in some cases less than five minutes) and outperform zero-shot classifiers. Therefore, according to examples of the disclosure a classifier model may be trained and implemented more quickly compared to previous methods. Experimental results show that models trained with users (e.g., domain experts) who provide labels for difficult or nuanced concepts (e.g., a subjective concept) outperform models trained with labels from crowd raters who may not share the same interpretation of the concept and who may not be domain experts. Experimental results also show that the disclosed classifier model outperforms zero-shot baselines with respect to concepts which are more susceptible to subjective interpretation. Experimental results further show that in some implementations the disclosed classifier model outperforms zero-shot baselines where the classifier model is trained based on ratings for a first set of images (e.g., 100 images). Experimental results further show that in some implementations the disclosed classifier model further outperforms zero-shot baselines where the classifier model is trained based on ratings for a first set of images (e.g., 100 images) and based on ratings for a second set of images (e.g., another 100 images) in a single active learning round.

With reference now to the drawings, example embodiments of the disclosure will be discussed in further detail.

### Example Devices and Systems

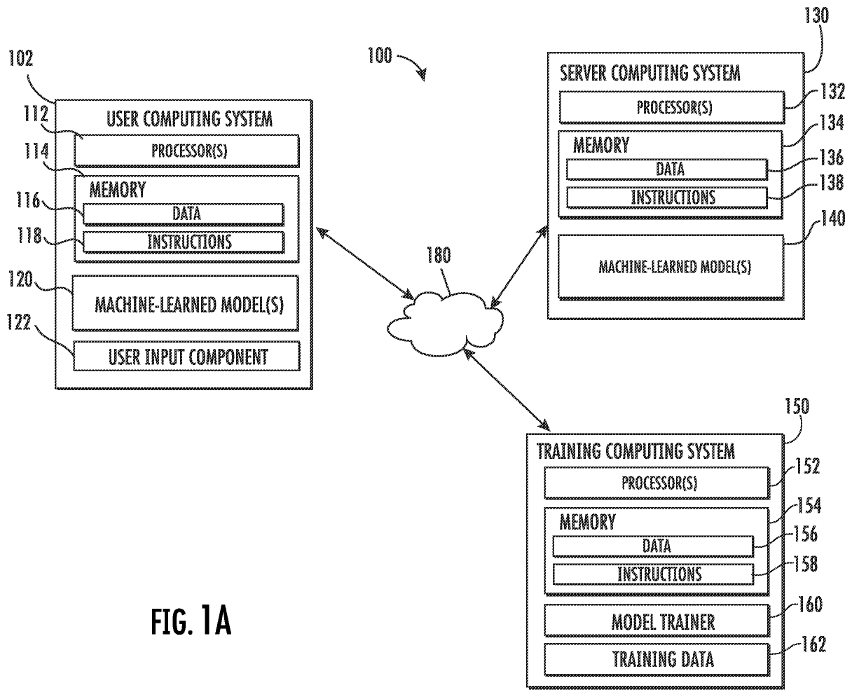

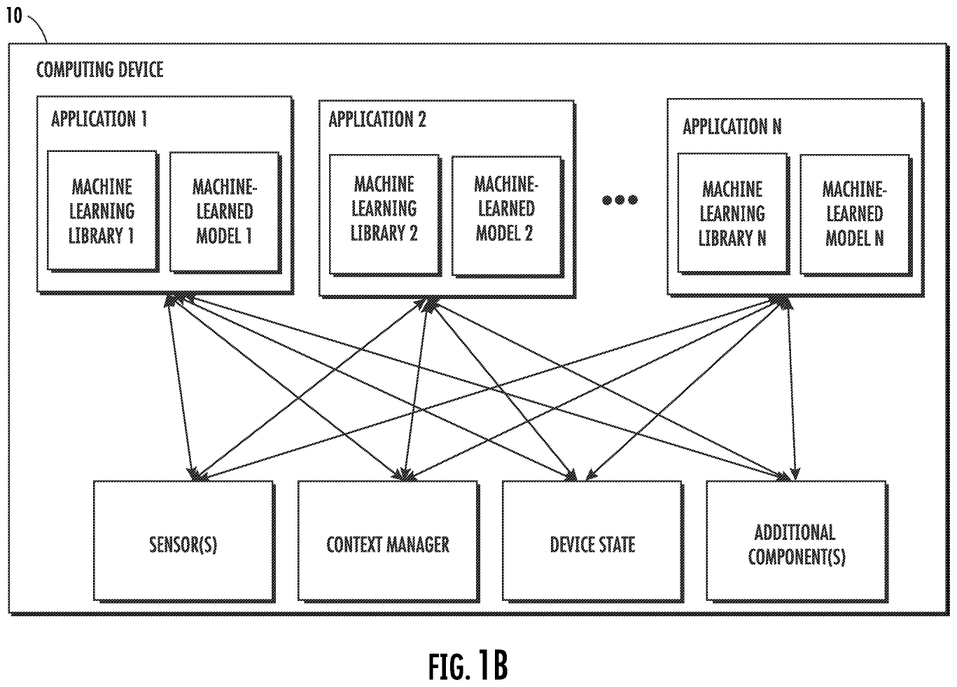

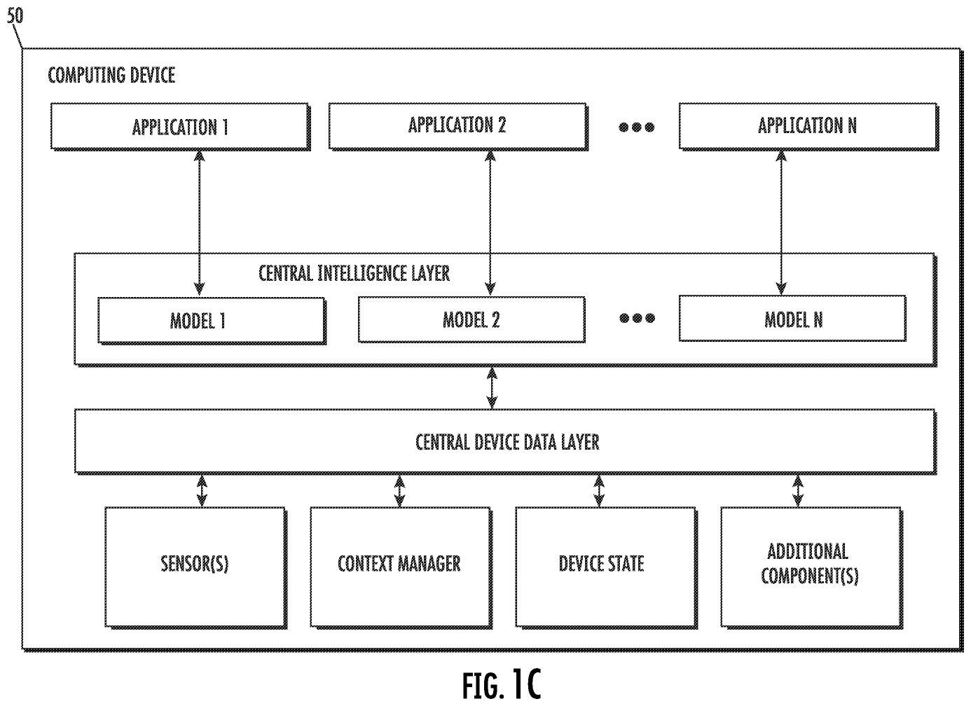

FIG. 1A depicts a block diagram of an example computing system 100 that performs various tasks using a machine-learned model (e.g., a classifier model) according to example embodiments of the disclosure. The system 100 includes a user computing system 102, a server computing system 130, and a training computing system 150 that are communicatively coupled over a network 180.

The user computing system 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing system 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing system 102 to perform operations.

In some implementations, the user computing system 102 can store or include one or more machine-learned models 120 (e.g., one or more classifier models, one or more binary classifier models, etc.). For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to the drawings herein.

In some implementations, the one or more machine-learned models 120 can be received from the server computing system 130 over network 180, stored in the memory 114, and then used or otherwise implemented by the one or more processors 112. In some implementations, the user computing system 102 can implement multiple parallel instances of a single machine-learned model 120 (e.g., to perform parallel tasks across multiple instances of the machine-learned model 120).

More particularly, the machine-learned models disclosed herein (e.g., including one or more classifier models which may include binary classifier models and may also be referred to as agile models), may be implemented to perform various tasks related to an input query which relates to imagery and a concept defined by a user. According to examples of the disclosure, a machine-learned model may be developed by a user based on a concept defined by the user (e.g., including a plurality of text phrases) and from which relevant images (e.g., 100 images) from a large unlabeled dataset for the user to rate can be mined. The rated images are used by the computing system to automatically train an initial classifier model for the concept. The initial classifier model can be improved by implementing a round of active learning by which additional images (e.g., another 100 images) are mined based on the initial classifier model by the computing system for the user to rate. The user rates the additional images and the computing system automatically retrains the initial classifier model for the concept to obtain an updated classifier model. Further rounds of active learning can be repeated until the user is satisfied with the output classifier model, until the user no longer has time to continue training the classifier model, until the classifier model achieves a threshold performance value, etc. During the process for training the classifier model, the user's input is used for only two types of tasks, which require no machine learning experience: first in providing the input defining the concept and second in rating images which are automatically selected by the computing system. Thus, the remaining processes for training the classifier model are performed automatically by the computing system, including data selection and model training. For example, using such automated processes users do not need to hire a machine-learning or computer vision engineer to build their classifiers and a machine-learned classifier model which outperforms other models (e.g., zero-shot) can be obtained quickly.

The machine-learned classifier models trained according to the methods described herein may be utilized to assign or categorize input data to one or more predefined classes or categories. For example, a binary classifier model trained according to the methods described herein may be utilized to categorize or classify input data into one of two possible classes or categories. For example, the machine-learned classifier models disclosed herein may be utilized for classifying images (e.g., for image recognition), to categorize text data according to a sentiment, for diagnosis purposes, to detect outliers or defects, etc.

Additionally, or alternatively, one or more machine-learned models 140 can be included in or otherwise stored and implemented by the server computing system 130 that communicates with the user computing system 102 according to a client-server relationship. For example, the machine-learned models 140 can be implemented by the server computing system 130 as a portion of a web service (e.g., a recommendation service, a search service, an image analysis service, and the like). Thus, one or more machine-learned models 120 can be stored and implemented at the user computing system 102 and/or one or more machine-learned models 140 can be stored and implemented at the server computing system 130.

The user computing system 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other devices by which a user can provide user input (e.g., a camera which captures an image).

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the machine-learned models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example machine-learned models 140 are discussed herein with reference to the drawings.

The user computing system 102 and/or the server computing system 130 can train the machine-learned models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing system 102 and/or the server computing system 130 using various training or learning techniques, such as, for example, backwards propagation of errors. For example, a loss function can be back propagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, various datasets which may be stored remotely or at the training computing system 150. For example, in some implementations an example dataset utilized for training includes the ImageNet21k dataset and LAION-400M dataset. However, other datasets may be utilized (e.g., images from external websites, ImageNet1k, iNaturalist 2019, etc.).

In some implementations, if the user has provided consent, the training examples can be provided by the user computing system 102. Thus, in such implementations, the machine-learned model 120 provided to the user computing system 102 can be trained by the training computing system 150 on user-specific data received from the user computing system 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the disclosure can be image data (e.g., one or more images). The machine-learned model(s) can process the image data to generate an output. As an example, the machine-learned model(s) can process the image data to generate an image classification output (e.g., a classification or categorization of the image data, etc.).

In some implementations, the input to the machine-learned model(s) of the disclosure can be text or natural language data. The machine-learned model(s) can process the text or natural language data to generate an output. As an example, the machine-learned model(s) can process the text or natural language data to generate a classification output.

In some implementations, the input to the machine-learned model(s) of the disclosure can be speech data. The machine-learned model(s) can process the speech data to generate an output. As an example, the machine-learned model(s) can process the speech data to generate a classification output.

FIG. 1A illustrates one example computing system that can be used to implement aspects of the disclosure. Other computing systems can be used as well. For example, in some implementations, the user computing system 102 can include the model trainer 160 and the training data 162. In such implementations, the machine-learned models 120 can be both trained and used locally at the user computing system 102. In some of such implementations, the user computing system 102 can implement the model trainer 160 to personalize the machine-learned models 120 based on user-specific data.

FIG. 1B depicts a block diagram of an example computing device 10 that performs according to example embodiments of the disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

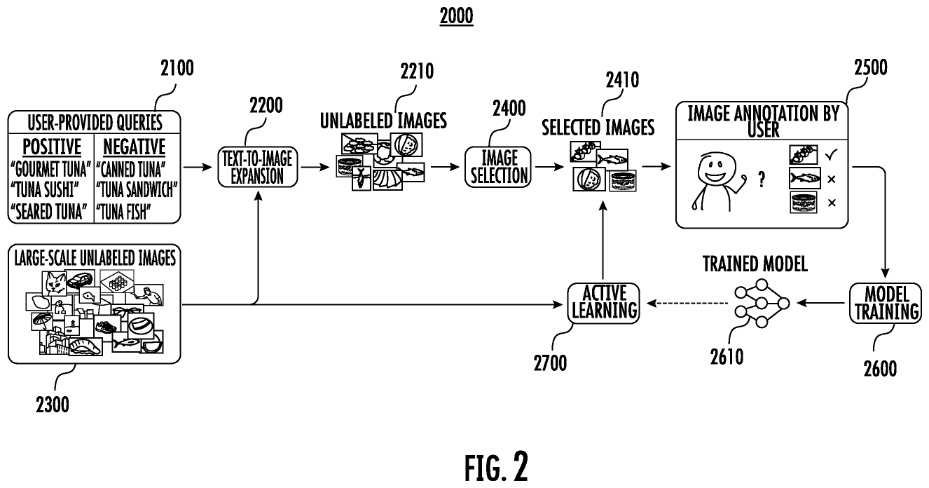

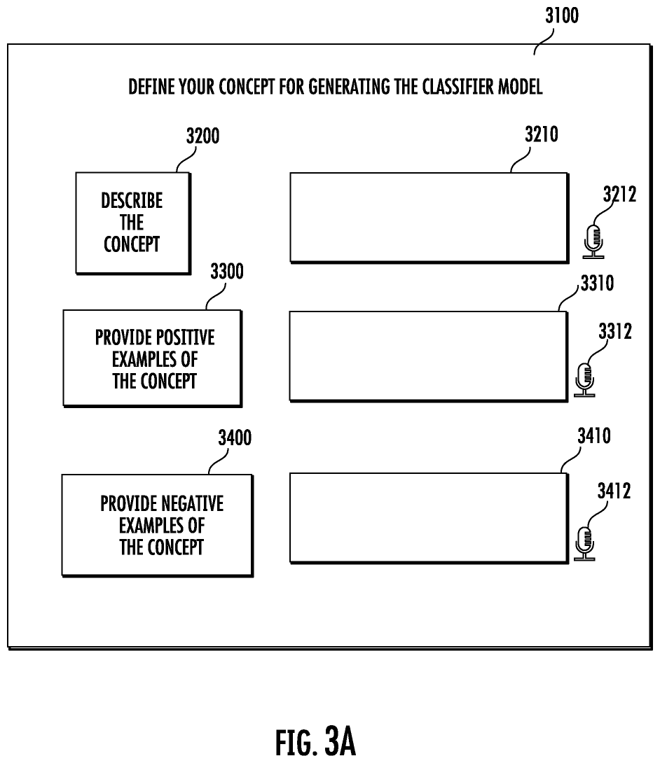

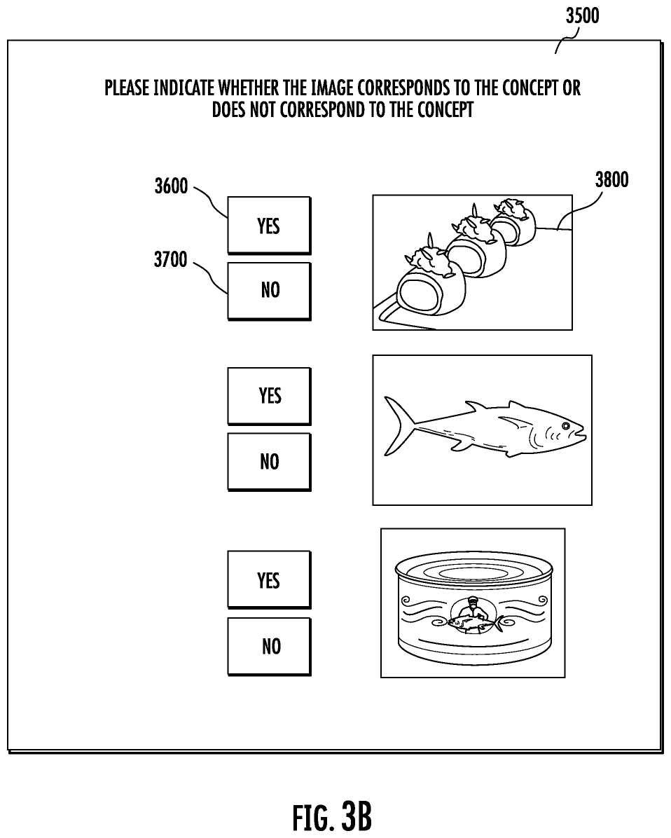

FIG. 2 depicts a flow chart diagram of an example method for training a machine-learned model (e.g., a classifier model), according to example embodiments of the disclosure. In some implementations, the machine-learned models described herein (e.g., including one or more classifier models which may include binary classifier models and may also be referred to as agile models) are trained to receive an input which can be directed to a concept, for example, a subjective concept that may be susceptible to various interpretations. FIGS. 3A-3B depict example graphical user interface screens for training an example machine-learned model, according to example embodiments of the disclosure.

Although shown in a particular sequence or order, unless otherwise specified, the order of the processes depicted in FIG. 2 (or other methods described herein) can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In the example of FIG. 2, the input is related to the concept of “gourmet tuna”. In the example of FIG. 2, a chef (e.g., a professional chef such as a sushi chef) may wish to generate a machine-learned model that is capable of classifying images which correspond to (or are positive examples of) “gourmet tuna”. The professional chef (e.g., a domain expert) may have a particular interpretation or opinion as to what kinds of foods might constitute “gourmet tuna” or be thought of as being representative of “gourmet tuna”. For example, a professional chef may think of gourmet tuna as corresponding to seared tuna, tuna sushi, and the like. Thus, images output by the classifier model are to be representative of the concept according to an input by a particular user (e.g., a domain expert such as the chef in the “gourmet tuna” example). On the other hand, the professional chef may view images that contain canned tuna, tuna sandwiches, and tuna fish as not being representative of “gourmet tuna”.

In contrast to the beliefs held by a domain expert concerning a particular concept, a majoritarian crowd of users who are not domain experts may have varied opinions concerning what constitutes or is representative of the concept. Therefore, ratings or labels given to images by the crowd may not be an accurate reflection of the view of the concept held by the user who wishes to generate the classifier model, which may lead to poor performance of the classifier model. For example, a graduate student may believe well-prepared tuna sandwiches correspond to “gourmet tuna”, however such an interpretation would be inconsistent with the user's interpretation of the concept.

FIG. 2 illustrates an agile modeling framework 2000 by which a user (e.g., a domain expert) can be guided by a computing system (e.g., any of user computing system 102, server computing system 130, and training computing system 150) to create a classifier model (e.g., an image classifier model). For example, the agile modeling framework 2000 may be implemented by execution of an application provided at or provided to the computing system for generating the classifier model.

For example, at 2100 the computing system may be configured to provide a tool (e.g., a graphical user interface) for the user to define the concept. That is, the computing system may be configured to receive an input from a user relating to a concept. For example, the computing system may be configured to provide the user with a tool to input one or more text phrases to describe the concept. For example, the computing system may be configured to provide the user with a tool to input one or more text phrases to describe the concept using both positive examples or positive phrases which can describe the concept as a whole or indicate specific visual modes, and negative examples or negative phrases which are related but not necessarily part of the concept.

FIG. 3A depicts an example graphical user interface which the computing system may be configured to provide for presentation to the user (e.g., via a display device) of the computing system. As shown in FIG. 3A, the graphical user interface 3100 may include a first user interface element 3200 to indicate to the user to describe the concept. For example, the graphical user interface 3100 may include a text box 3210 for a user to provide a text input and/or a second user interface element 3212 to provide a voice input to describe the concept. The graphical user interface 3100 may include a third user interface element 3300 to indicate to the user to provide positive examples of the concept. For example, the graphical user interface 3100 may include a text box 3310 for a user to provide a text input and/or a fourth user interface element 3312 to provide a voice input to describe positive examples of the concept. The graphical user interface 3100 may include a fifth user interface element 3400 to indicate to the user to provide negative examples of the concept. For example, the graphical user interface 3100 may include a text box 3410 for a user to provide a text input and/or a sixth user interface element 3412 to provide a voice input to describe negative examples of the concept. The graphical user interface 3100 is only an example, and other configurations of a graphical user interface may be implemented to obtain user inputs relating to the concept. For example, in some implementations an option for providing negative examples of the concept may be omitted.

Referring back to FIG. 2, the user-provided queries or prompts indicate positive examples (“gourmet tuna”, “tuna sushi”, and “seared tuna”) and negative examples (“canned tuna”, “tuna sandwich”, and “tuna fish”). For example, the user-provided queries or prompts may be input via user input component 122 (e.g., via a text input, voice input, etc.). Expressing the concept in terms of both positive and negative phrases is an effective way of mining positive and hard negative examples for training the classifier model. The positive phrases allow the user to express both the concept as a whole (e.g., “gourmet tuna”) and specific visual modes of it (e.g., “seared tuna”, “tuna sushi”, etc.). The negative phrases are important in finding negative examples that could be easily confused by raters (e.g., crowd raters).

At 2200, in a text-to-image expansion operation the computing system may be configured to mine relevant images from a large unlabeled dataset of images for the user to rate. For example, at 2200 the computing system may be configured to obtain (e.g., automatically obtain or select) a first set of images 2410 from an unlabeled image dataset 2300 based on the input received at 2100. The computing system may be configured to identify a first set of relevant training images (e.g., 100 training images) from the unlabeled dataset of images, based on the phrases provided by the user. For example, in some implementations an example dataset utilized for training includes the ImageNet21k dataset and LAION-400M dataset. However, other datasets may be utilized (e.g., images from external websites, ImageNet1k, iNaturalist 2019, etc.).

In some implementations, the computing system may be configured to implement one or more image-text models, including Contrastive Language-Image Pretraining (CLIP) and A Large-scale ImaGe and Noisy-text embedding (ALIGN). CLIP is a known image-text model that learns to associate images and their textual descriptions in a shared embedding space through contrastive learning. ALIGN is another known image-text co-embedding approach that aligns images and text in a shared space. ALIGN learns to align the representations of images and their textual descriptions by minimizing the contrastive loss.

The computing system is configured to co-embed both the unlabeled image dataset and the text phrases provided by the user into the same space and perform a nearest-neighbors search to retrieve or select the first set of images 2410 from among the unlabeled dataset of images to obtain images (e.g., 100 images) which are nearest to each text embedding. For example, the computing system may utilize existing nearest-neighbors approaches which are fast due to their hybrid solution of trees and quantization (e.g., a quantization based approach for fast approximate maximum inner product search) to identify the relevant images (e.g., first set of images 2410) from the unlabeled image dataset 2210 (which may correspond to the large-scale unlabeled image dataset 2300 or the unlabeled images represented at 2210). At 2400, from the set of all nearest neighbors, the computing system may be configured to randomly sample or select the first set of images 2410 (e.g., 100 images) for the user to rate from among the images provided in the unlabeled image dataset 2210. For example, the computing system may be configured to obtain images which correspond to positive and negative phrases, as the negative phrases are helpful in identifying hard negative examples.

At operation 2500, the computing system may be configured to receive an image annotation operation performed by the user which identifies images that correspond to or do not correspond to the concept. For example, the computing system may be configured to obtain a first rating via the user for each image from the first set of images. For example, the rating may be input via the user input component 122 (e.g., via a text input, voice input, touch input, etc.). The rating may include a positive indication that the image corresponds to the concept or a negative indication that the image corresponds to the concept, for example. For example, the computing system may be configured to provide a tool (e.g., a graphical user interface) by which the user can rate the images, specifying whether each image is either positive or negative for the concept of interest. For example, the tool may be configured to provide, for presentation to the user, the first set of images so that the user can label the images (e.g., by specifying whether the image is either positive or negative for the concept of interest). In some implementations, the user may be shown one image at a time and asked to select whether the image is positive or negative. In some implementations, the user may be shown a plurality of images at the same time on the same graphical user interface and asked to rate each image individually. In some experiments the median time for users to rate a single image was 1.7±0.5 seconds. To rate the first set of images (e.g., 100 images) and train an initial classifier model, approximately 3 minutes elapsed.

FIG. 3B depicts an example graphical user interface which the computing system may be configured to provide for presentation to the user (e.g., via a display device) of the computing system. For example, the graphical user interface may include user interface elements which are selectable to indicate whether an image is a positive image corresponding to the concept or a negative image that does not correspond to the concept. As shown in FIG. 3B, the graphical user interface 3500 may include a first user interface element 3600 to indicate that an image 3800 is a positive example of the concept and a second user interface element 3700 to indicate that the image 3800 is a negative example of the concept. Similar user interface elements may be provided for each image displayed to the user. The graphical user interface 3500 is only an example, and other configurations of a graphical user interface may be implemented to obtain user inputs relating to rating the concept. For example, in some implementations, icons (e.g., a thumbs up or thumbs down) may be provided for selection by the user to select, or the user may swipe an image to the left or right to indicate a positive or negative rating.

Subsequent to the images being rated by the user, at operation 2600 the computing system may be configured to train a classifier model (e.g., a binary classifier model) for the concept. For example, the computing system may be configured to automatically train the classifier model to generate an initial classifier model 2610. That is, the computing system may be configured to train the classifier model relating to the concept based on the first set of images rated by the user.

In some implementations, the computing system may be configured to train a binary image classifier using all previously labeled data (e.g., the images labeled by the user who may be a domain expert). For example, the computing system may implement a few-shot machine-learned model with respect to the initial classifier model due to the lack of large-scale data. In another implementation, the computing system is configured to utilize and implement one or more pretrained models including CLIP and ALIGN to train a neural network (e.g., a small multilayer perceptron (MLP), with only 1-3 layers), on top of image embeddings provided by such large pretrained models. These embeddings provide external information to address the low data challenge faced due to the limited number of images which are labeled, while allowing the computing system to train a low capacity model that can be trained fast and is less prone to overfitting. According to some experimental results generally the ALIGN pretrained models outperform their CLIP counterparts for almost every concept presented (e.g., by achieving increases in the Area Under the Precision-Recall Curve metric of about 11% to 13%).

At 2700, the computing system may be configured to implement active learning processes to improve the performance of the initial classifier model very quickly via one or more rounds of active learning. For example, each round of active learning may include: (1) the framework invoking an algorithm to select a second set of images from millions of unlabeled images to rate; (2) the user rating each of the images from the second set of images; and (3) the system retraining the classifier model with all the available labeled data (e.g., the first set of images and the second set of images and so on) to obtain an updated classifier model. The whole active learning procedure may operate on millions of images and can return a new classifier model in a short period of time (e.g., under 3 minutes). Generally, previous active learning methods do not involve the actual intended users of the classifier model rating images but instead rely on crowd users. In contrast, according to example embodiments disclosed herein, the active learning rater is the same user who is creating and using the classifier model (e.g., a domain expert who has defined the concept).

The active learning process can be repeated one or more times to iteratively improve performance. When selecting samples to rate, state-of-the-art active learning methods generally optimize for improving the model the fastest. However, as the computing system is training a classifier model in real-time while the user (who also rates the images) is waiting, constraints on a time to train the classifier model exist so as to minimize the user-perceived latency. Therefore, in some implementations active learning methods that rely on heavy optimization strategies may not be used. For example, in some implementations the computing system may be configured to implement a known and fast method referred to as uncertainty sampling or margin sampling, which selects images for which the classifier model is uncertain. For example, given a model with parameters θ and a sample x, the uncertainty score may be defined as P_{θ}(y₁|x)−P_{θ}(y₂|x), where y₁ and y₂ are the highest and second-highest probabilities predicted by the model. As another example, the computing system may be configured to implement the active learning component through a known margin+positive mining strategy. The computing system may also utilize other definitions of uncertainty including least confidence and entropy. The computing system may be configured to perform further rounds of active learning until the user is satisfied with the output classifier model, until the user no longer has time to continue training the classifier model, until the user provides an input ending the training session, until a predetermined amount of time elapses, until the classifier model achieves a threshold performance value, etc.

For example, at 2700 the active learning operation may include the computing system obtaining the second set of images (e.g., 50 images, 100 images, 200 images, etc.) from the unlabeled image dataset (e.g., unlabeled image dataset 2300) based on the initial classifier model 2610 which was trained based on the first set of images 2410. The computing system may be configured to provide for presentation the second set of images to the user similar to operation 2500, and a graphical user interface similar to that shown in FIG. 3B may be provided for presentation to obtain a second rating via the user for each image from the second set of images. Operation 2600 may be repeated by the computing system to retrain the initial classifier model (e.g., a binary classifier model) for the concept. For example, the computing system may be configured to automatically retrain the initial classifier model to generate or obtain an updated classifier model. That is, the computing system may be configured to retrain the classifier model relating to the concept based on the first set of images rated by the user and the second set of images rated by the user to obtain the updated classifier model. For example, the computing system may be configured to utilize and implement the one or more pretrained models including CLIP and ALIGN to retrain the initial classifier model (e.g., a small multilayer perceptron (MLP), with only 1-3 layers), on top of image embeddings provided by these large pretrained models. The active learning process may be repeated as discussed above in a similar manner. In some implementations, the number of images automatically selected by the computing system for rating during each active learning round may be varied. For example, in a first round of active learning the second set of images may include 50 images and in a second round of active learning the third set of images may include 100 images and in a third round of active learning the fourth set of images may include 200 images. In some implementations, the number of images automatically selected by the computing system for rating during each active learning round may be fixed. Experimental results show that smaller batch sizes (e.g., 50 images) for performing active learning obtain better performance overall compared to larger batch sizes (e.g., 100 images, 200 images) based on a same number of overall images rated. However, smaller batch sizes involve a higher frequency of retraining the classifier model leading to longer time investment from the users to train the classifier model.

At the conclusion of training the classifier model, the user (computing system) may utilize the classifier model for various purposes. For example, the generated classifier model may be implemented via a computing system in object recognition systems, facial recognition systems, product categorization systems, quality control systems, medical diagnosis systems, etc. For example, in the context of training a classifier model with respect to the concept of “gourmet tuna” the user can implement the generated classifier model via a computing system to identify gourmet tuna in images or videos, to monitor social media platforms for posts, images, or videos relating to gourmet tuna, to identify gourmet tuna products, etc.

### Example Methods

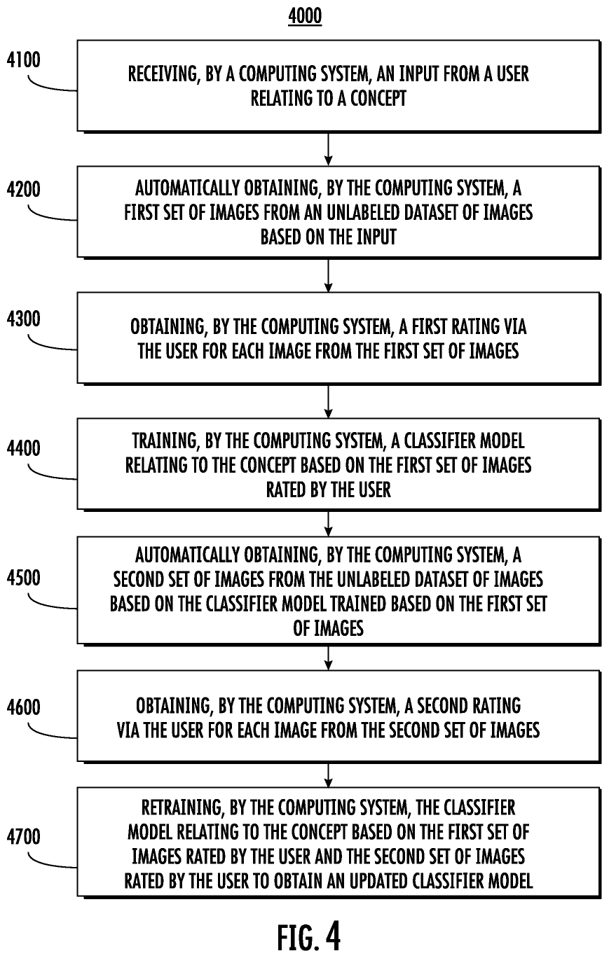

FIG. 4 depicts a flow chart diagram of an example method to perform according to example embodiments of the disclosure. Although FIG. 4 depicts operations performed in a particular order for purposes of illustration and discussion, the methods of the disclosure are not limited to the particularly illustrated order or arrangement. The various operations of the method 4000 can be omitted, rearranged, combined, and/or adapted in various ways without deviating from the scope of the disclosure.

According to some examples of the disclosure, a computing system (e.g., user computing system 102, server computing system 130, training computing system 150) may be configured to train a classifier model based on a user rating (e.g., where the user is the entity desiring to generate the classifier model, for example in real-time, provides the concept, and may be a domain expert with respect to the concept).

For example, at 4100, a computing system (e.g., user computing system 102, server computing system 130, training computing system 150) receives an input from a user relating to a concept. For example, the computing system may be configured to provide a tool (e.g., a graphical user interface) for the user to define the concept. That is, the computing system may be configured to receive an input from a user relating to a concept, for example, via the tool. The input may include one or more text phrases to describe the concept. The one or more text phrases may describe the concept using both positive examples or positive phrases which can describe the concept as a whole or indicate specific visual modes, and negative examples or negative phrases which are related but not necessarily part of the concept. FIG. 3A illustrates an example graphical user interface 3100 by which the user can provide the input relating to the concept.

At 4200, the computing system (e.g., user computing system 102, server computing system 130, training computing system 150) automatically obtains a first set of images from an unlabeled dataset of images based on the input. As previously described with respect to FIG. 2, the computing system may be configured to obtain (e.g., automatically obtain or select) a first set of images from an unlabeled dataset of images based on the input received at 4100. For example, the computing system may be configured to co-embed both the unlabeled image dataset and the text phrases provided by the user into the same space and perform a nearest-neighbors search to retrieve or select the first set of images from among the unlabeled dataset of images to obtain images (e.g., 100 images) which are nearest to each text embedding.

At 4300, the computing system (e.g., user computing system 102, server computing system 130, training computing system 150) obtains a first rating via the user for each image from the first set of images. For example, the rating may be input via the user input component 122 (e.g., via a text input, voice input, touch input, etc.). The rating may include a positive indication that the image corresponds to the concept or a negative indication that the image corresponds to the concept, for example. FIG. 3B illustrates an example graphical user interface 3500 by which the user can provide the first rating.

At 4400, the computing system (e.g., user computing system 102, server computing system 130, training computing system 150) trains (e.g., automatically trains) a classifier model relating to the concept based on the first set of images rated by the user at 4300. For example, the computing system may be configured to utilize and implement one or more pretrained models including CLIP and/or ALIGN models to train a neural network (e.g., a small multilayer perceptron (MLP), with only 1-3 layers), on top of image embeddings provided by such large pretrained models.

At 4500, the computing system (e.g., user computing system 102, server computing system 130, training computing system 150) automatically obtains a second set of images from the unlabeled dataset of images based on the classifier model trained based on the first set of images. For example, in some implementations the computing system may be configured to implement uncertainty sampling or margin sampling to automatically obtain or select images (e.g., 100 images) from among the images in the unlabeled image dataset, for which the classifier model is uncertain.

At 4600, the computing system (e.g., user computing system 102, server computing system 130, training computing system 150) obtains a second rating via the user for each image from the second set of images. For example, like 4300 at 4600 the rating may be input via the user input component 122 (e.g., via a text input, voice input, touch input, etc.). The rating may include a positive indication that the image corresponds to the concept or a negative indication that the image corresponds to the concept, for example. FIG. 3B illustrates an example graphical user interface 3500 by which the user can provide the second rating.

At 4700, the computing system (e.g., user computing system 102, server computing system 130, training computing system 150) retrains (e.g., automatically retrains) the classifier model relating to the concept based on the first set of images rated by the user and the second set of images rated by the user to obtain an updated classifier model. For example, the computing system may be configured to utilize and implement the one or more pretrained models including CLIP and ALIGN to retrain the previously obtained classifier model (e.g., a small multilayer perceptron (MLP), with only 1-3 layers), on top of image embeddings provided by these large pretrained models.

For example, operations 4500, 4600, and 4700 may be repeated in an iterative manner until the user is satisfied with the output classifier model, until the user no longer has time to continue training the classifier model, until the user provides an input ending the training session, until a predetermined amount of time elapses, until the classifier model achieves a threshold performance value, etc.

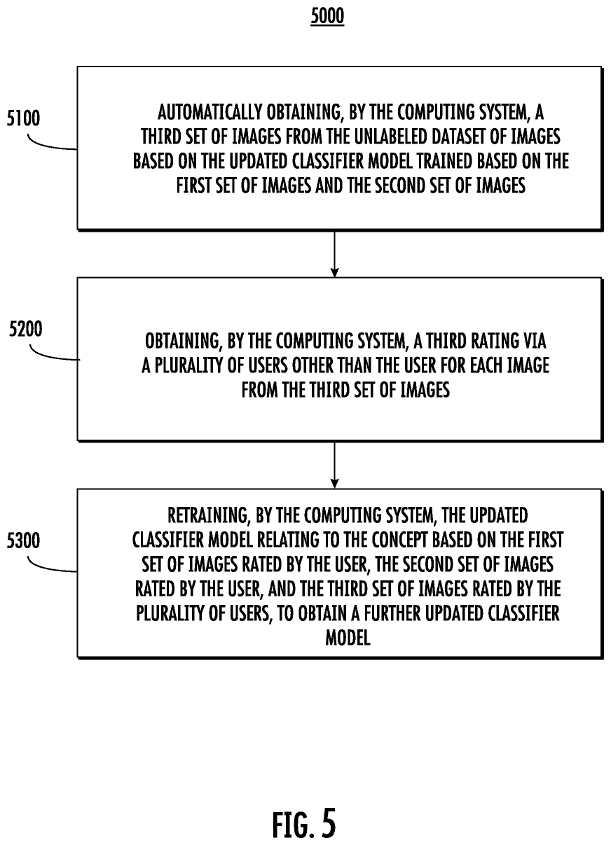

FIG. 5 depicts a flow chart diagram of an example method to perform according to example embodiments of the disclosure. Although FIG. 5 depicts operations performed in a particular order for purposes of illustration and discussion, the methods of the disclosure are not limited to the particularly illustrated order or arrangement. The various operations of the method 5000 can be omitted, rearranged, combined, and/or adapted in various ways without deviating from the scope of the disclosure.

According to some examples of the disclosure, a computing system (e.g., user computing system 102, server computing system 130, training computing system 150) may be configured to train a classifier model based on a user rating (e.g., where the user is the entity desiring to generate the classifier model, for example in real-time, provides the concept, and may be a domain expert with respect to the concept). According to some examples of the disclosure, a computing system (e.g., user computing system 102, server computing system 130, training computing system 150) may be configured to train a classifier model based on a user rating (e.g., where the user is the entity desiring to generate the classifier model, for example in real-time, provides the concept, and may be a domain expert with respect to the concept) and further based on ratings provided by one or more crowd users (e.g., where the crowd users are users other than the user desiring to generate the classifier model, do not provide the concept and may be unfamiliar with the concept or have different views of the concept than the user, and may not be domain experts with respect to the concept).

The method 5000 illustrated in FIG. 5 may be an extension of the method of FIG. 4. That is, the operations of FIGS. 4 and 5 may be performed together as a single method. For example, in some implementations the classifier model trained by the user with respect to the operations of FIG. 4 can continue to be trained via other users (e.g., crowd users) with respect to the method of FIG. 5.

For example, the operations of FIG. 5 may be performed after the user no longer has time to continue training the classifier model, in response to the user providing an input ending their training session, in response to a predetermined amount of time elapsing with respect to a training session associated with the user, or in response to the classifier model achieving a threshold performance value after being trained by the user, etc.

For example, at 5100, the computing system (e.g., user computing system 102, server computing system 130, training computing system 150) obtains (e.g., automatically obtains) a third set of images (e.g., 100 images, 500 images, 1000 images, etc.) from the unlabeled dataset of images based on the updated classifier model trained by the user based on the first set of images and the second set of images (e.g., as trained according to the method of FIG. 4). In some implementations, the number of images obtained by the computing system with respect to the third set of images may be greater than the number of the first set of images and greater than the number of the second set of images. For example, crowd users may not have similar time constraints as the user and may be able to expend more time rating images than the user in a given training session.

At 5200, the computing system (e.g., user computing system 102, server computing system 130, training computing system 150) obtains a third rating via a plurality of users other than the user for each image from the third set of images. For example, the plurality of users may correspond to crowd users or crowd raters. The computing system may be configured to provide a tool (e.g., a graphical user interface) for the plurality of users to provide the third rating.

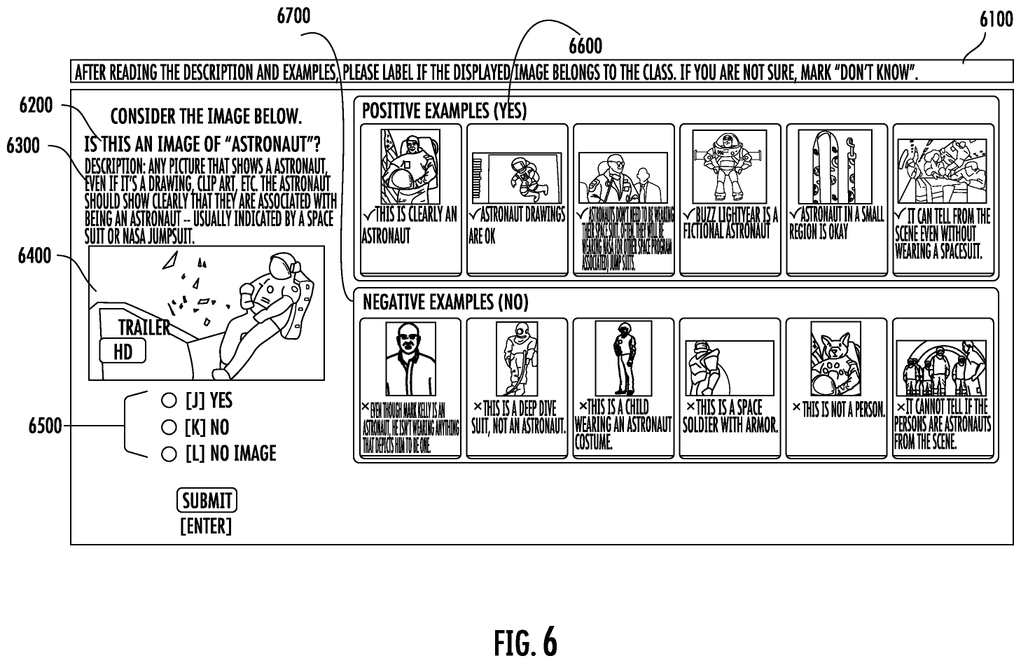

FIG. 6 depicts an example graphical user interface screen for crowd raters (e.g., the plurality of users) to label images, according to example embodiments of the disclosure. Different from the graphical user interface of FIG. 3B, in FIG. 6 the graphical user interface 6100 may include additional information to provide the plurality of users with information relating to the concept as understood and defined by the user, to better align the interpretation of the concept of the user and the interpretations of the concept of the plurality of users. For example, the concept may be identified to the plurality of users. In FIG. 6, the plurality of users are given a description 6200 that identifies the concept as an “astronaut” and asks the plurality of users to indicate whether an image 6400 (from the third set of images) is indicative of the concept (e.g., by selecting one of the options 6500). The computing system may also be configured to provide a concept description 6300. In FIG. 6 the concept description 6300 describes the user's interpretation of the concept for reference by the plurality of users in rating the image 6400. The computing system may also be configured to provide positive examples 6600 and negative examples 6700 relating to the concept. In FIG. 6 the graphical user interface 6100 includes images of positive examples 6600 with corresponding explanations of why the image corresponded to the concept and images of negative examples 6700 with corresponding explanations of why the image did not correspond to the concept.

In some implementations the description of the concept may be provided by the user who desires to generate the classifier model. In some implementations the images of the positive and negative examples of the concept (and the accompanying explanations) may be provided or selected by the user. In other implementations, the description of the concept, the images of the positive and negative examples of the concept (and the accompanying explanations) may be generated by a generative machine-learned model.

In some implementations, a corresponding rating from a plurality of users from among the plurality of users may be averaged or counted to determine a majority rating, and the average rating or majority decision may be counted as a single rating. For example, an image may be sent to three crowd users and the label (rating) may be decided by the majority vote. Thus, a single rating from crowd users provided for training the classifier model may be obtained based on ratings from a plurality of the crowd users.

At 5300, the computing system (e.g., user computing system 102, server computing system 130, training computing system 150) retrains the updated classifier model relating to the concept based on the first set of images rated by the user, the second set of images rated by the user, and the third set of images rated by the plurality of users, to obtain a further updated classifier model. For example, in some implementations in retraining the updated classifier model relating to the concept the computing system may be configured to provide a weight to a rating obtained via the user which is higher than a weight which is provided to the ratings obtained via the plurality of users.

For example, operations 5100, 5200, and 5300 may be repeated in an iterative manner until the user is satisfied with the output classifier model, until the user no longer has time to continue training the classifier model, until the user provides an input ending the training session, until a predetermined amount of time elapses, until the classifier model achieves a threshold performance value, etc. Here, the user may obtain a classifier model which is initially trained based on ratings by the user, and the performance of the classifier model is further enhanced by crowd ratings which the user can passively obtain.

### Experimental Results

Example classifier models as described herein were implemented under various conditions and compared with results achieved by other models.

Source datasets referenced for obtaining the experimental results included the ImageNet21k dataset.

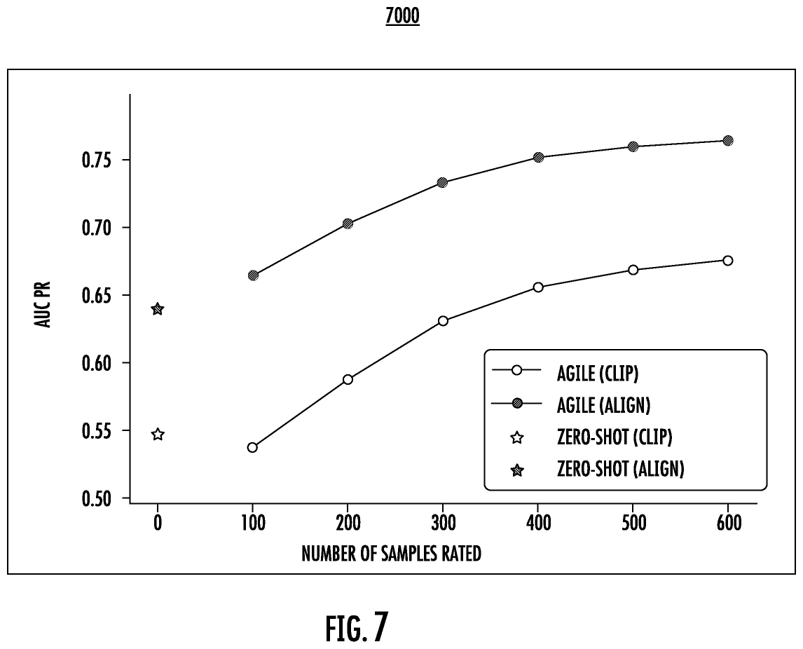

FIG. 7 depicts an example graph illustrating the trained classifier model performance against a zero-shot baseline approach, according to example embodiments of the disclosure. As shown in FIG. 3, instantiations of the agile (classifier) modeling framework are compared against a zero-shot baseline across two image-text co-embeddings: CLIP and ALIGN. As shown in graph 7000, the zero-shot performance is roughly on par with the classifier model trained on 100 images rated by the user. However, as the number of user ratings increases from 100 to 600 (e.g., through active learning rounds), the resulting classifier model outperforms the zero-shot baseline.

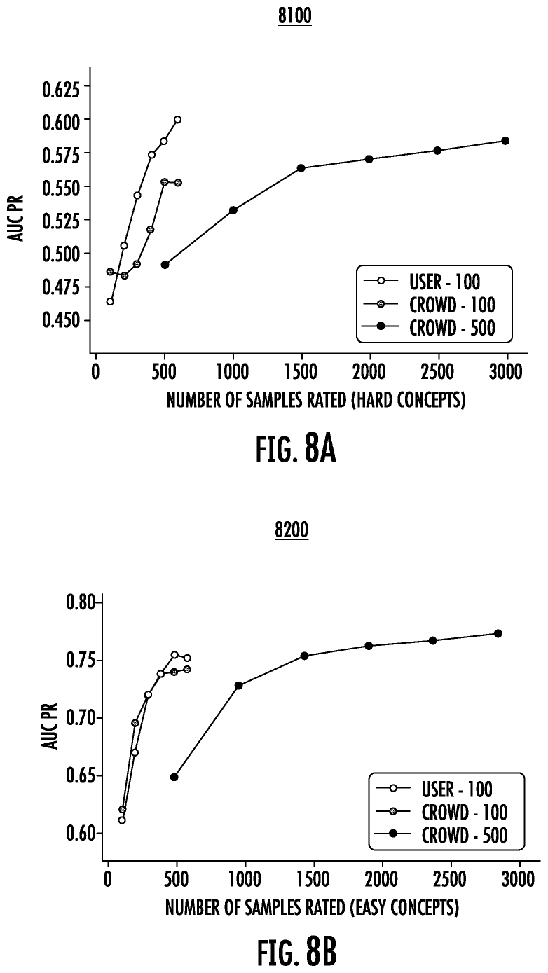

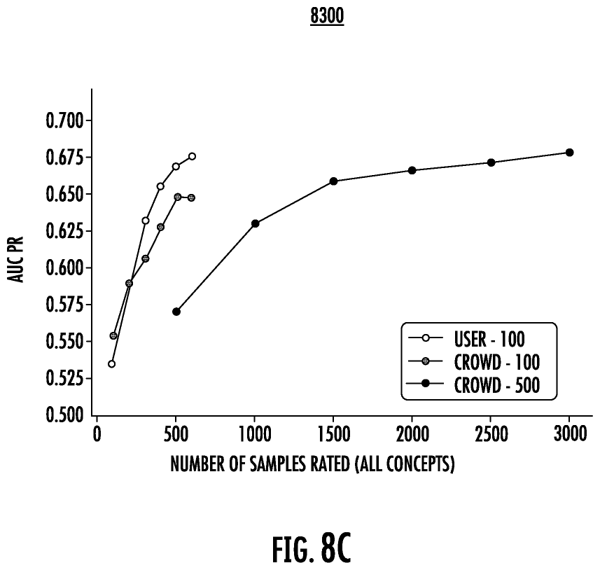

FIG. 8 depicts an example graph illustrating the trained classifier model performance against a zero-shot baseline approach, according to example embodiments of the disclosure. As shown in FIG. 3, instantiations of the agile (classifier) modeling framework are compared against a zero-shot baseline across two image-text co-embeddings: CLIP and ALIGN. As shown in graph 7000, the zero-shot performance is roughly on par with the classifier model trained on 100 images rated by the user. However, as the number of user ratings increases from 100 to 600 (e.g., through active learning rounds), the resulting classifier model outperforms the zero-shot baseline. For example, according to experimental results after only about 5 minutes of the user's time rating images, the trained classifier model outperforms the zero-shot baseline by at least 3% and after 24 minutes, the performance gain grows to 16%.

FIGS. 8A through 8C depicts graphs illustrating the trained classifier model performance based on user ratings against a classifier model trained based on crowd ratings, for different degrees of concept difficulty, according to example embodiments of the disclosure.

Users have an advantage over crowd raters in their ability to rate images according to their subjective specifications. However, this subjectivity, or “concept difficulty” may vary by concept. For example, if a concept is universally understood, the advantage may diminish. Conversely, complex, nuanced concepts are harder for crowd workers to accurately label. In obtaining the experimental results of FIGS. 8A-8C, concepts from a dataset were divided based on their difficulty, using zero-shot performance as a proxy for concept difficulty. Seven concepts having the highest zero-shot performance were considered “easy,” while the remaining seven concepts (which included more subjective concepts) were considered “hard.” FIGS. 8A through 8C illustrate a comparison of classifier models trained by three sets of raters: (1) User-100: Users rate 100 images for the initial model and every active learning round (total 600 images); (2) Crowd-100: Crowd workers rate 100 images for the initial model and every active learning round (total 600 images); and (3) Crowd-500: Crowd workers rated 500 images for the initial model and every active learning round (total 3000 images). During the experiment, crowd workers read instructions created by the users, who noted difficult cases that they found during labeling.

FIGS. 8A through 8C illustrate the average performance with respect to the “hard”, “easy” and “all” concepts as a function of the number of rated samples, using CLIP embeddings. FIG. 8A includes graph 8100 which illustrates results obtained by training models on hard concepts, with users (User-100) outperforming models trained with crowd raters, even when 5 times more ratings are obtained from the crowd (Crowd-500). Therefore, the disclosed classifier model achieves superior results in the context of harder, more nuanced and subjective concepts. FIG. 8B includes graph 8200 which illustrates results obtained by training models on easy concepts, with users (User-100) achieving similar performance compared to models trained with crowd raters, and outperforming models trained by crowd users who rated the same number of images (Crowd-100). FIG. 8C includes graph 8300 which illustrates results obtained by training models on all concepts, with users (User-100) achieving a similar or better performance compared to models trained with crowd raters.

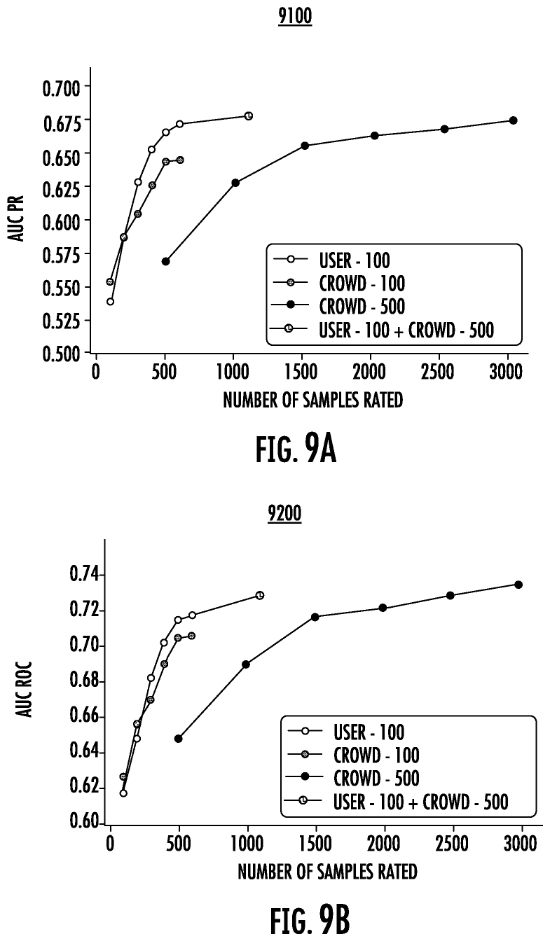

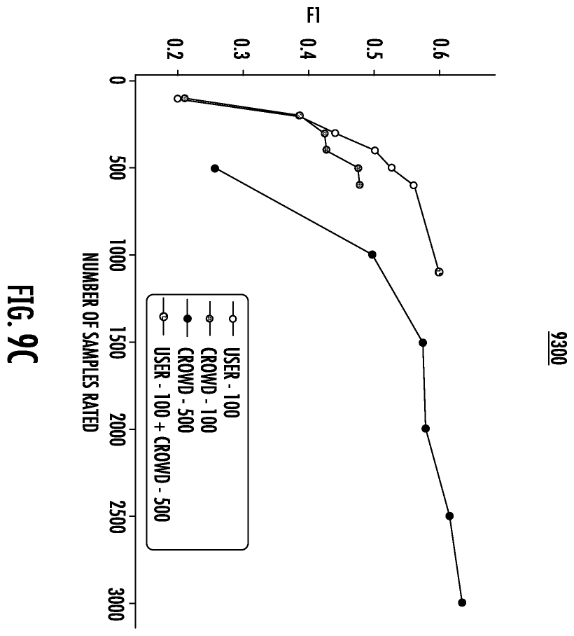

FIGS. 9A through 9C depict graphs illustrating the trained classifier model performance based on user ratings combined with crowd user ratings against classifier models trained based on user ratings or crowd ratings, according to example embodiments of the disclosure.

FIG. 9A includes graph 9100 which illustrates a comparison of results obtained according to a first metric (AUC PR) by training models based on user ratings (e.g., batch size of 100 images), crowd ratings with a batch size of 100 images, crowd ratings with a batch size of 500 images, and results obtained where, after the user rates images for five rounds via active learning, crowd users rated another set of images (a batch of 500 images) in another round of active learning (User-100 +Crowd-500). FIG. 9B includes graph 9200 which illustrates a comparison of results obtained according to a second metric (AUC ROC) and FIG. 9C includes graph 9300 which illustrates a comparison of results obtained according to a third metric (F1). With additional data from the crowd raters, the trained classifier model corresponding to User-100+Crowd-500 shows further improvements with respect to each of the measured metrics compared to User-100 and the other models.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

Aspects of the above-described example embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks, Blue-Ray disks, and DVDs; magneto-optical media such as optical discs; and other hardware devices that are specially configured to store and perform program instructions, such as semiconductor memory, read-only memory (ROM), random access memory (RAM), flash memory, USB memory, and the like. Examples of program instructions include both machine code, such as produced by a compiler, and files containing higher level code that may be executed by the computer using an interpreter. The program instructions may be executed by one or more processors. The described hardware devices may be configured to act as one or more software modules in order to perform the operations of the above-described embodiments, or vice versa. In addition, a non-transitory computer-readable storage medium may be distributed among computer systems connected through a network and computer-readable codes or program instructions may be stored and executed in a decentralized manner. In addition, the non-transitory computer-readable storage media may also be embodied in at least one application specific integrated circuit (ASIC) or Field Programmable Gate Array (FPGA).

Each block of the flowchart illustrations may represent a unit, module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently (simultaneously) or the blocks may sometimes be executed in the reverse order, depending upon the functionality involved.

While the subject matter has been described in detail with respect to various example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the subject matter as would be readily apparent to one of ordinary skill in the art. For instance, features illustrated or described as part of one embodiment can be used with another embodiment to yield a still further embodiment. Thus, it is intended that the disclosure covers such alterations, variations, and equivalents.

What is claimed is:

1. A computer-implemented method, comprising:
receiving, by a computing system, an input from a user relating to a concept;
automatically obtaining, by the computing system, a first set of images from an unlabeled dataset of images based on the input;
obtaining, by the computing system, a first rating via the user for each image from the first set of images;
training, by the computing system, a classifier model relating to the concept based on the first set of images rated by the user;
automatically obtaining, by the computing system, a second set of images from the unlabeled dataset of images based on the classifier model trained based on the first set of images;
obtaining, by the computing system, a second rating via the user for each image from the second set of images; and
retraining, by the computing system, the classifier model relating to the concept based on the first set of images rated by the user and the second set of images rated by the user to obtain an updated classifier model.

2. The computer-implemented method of claim 1, wherein the input comprises a plurality of text phrases.

3. The computer-implemented method of claim 2, wherein the plurality of text phrases includes at least one positive textual description relating to the concept and at least one negative textual description relating to the concept.

4. The computer-implemented method of claim 1, further comprising providing a rating tool to obtain the first rating and the second rating.

5. The computer-implemented method of claim 4, wherein
the rating tool comprises a user interface which displays each image from among the first set of images and the second set of images, and
the user interface includes user interface elements which are selectable to indicate whether an image is a positive image corresponding to the concept or a negative image that does not correspond to the concept.

6. The computer-implemented method of claim 1, wherein the classifier model is a binary classifier model.

7. The computer-implemented method of claim 6, wherein the first rating is a binary rating indicating whether an image from the first set of images is a positive image corresponding to the concept or a negative image that does not correspond to the concept.

8. The computer-implemented method of claim 1, wherein obtaining the first set of images from the unlabeled dataset of images based on the input comprises:
co-embedding the unlabeled dataset of images and the input into a same space, and
performing a nearest-neighbor search to retrieve the first set of images from among the unlabeled dataset of images to obtain images which are nearest to each text embedding.

9. The computer-implemented method of claim 1, further comprising:
automatically obtaining, by the computing system, a third set of images from the unlabeled dataset of images based on the updated classifier model trained based on the first set of images and the second set of images;
obtaining, by the computing system, a third rating via a plurality of users other than the user for each image from the third set of images; and
retraining, by the computing system, the updated classifier model relating to the concept based on the first set of images rated by the user, the second set of images rated by the user, and the third set of images rated by the plurality of users, to obtain a further updated classifier model.

10. The computer-implemented method of claim 9, wherein a number of the third set of images is greater than a number of the first set of images and greater than a number of the second set of images.

11. The computer-implemented method of claim 10, wherein retraining, by the computing system, the updated classifier model relating to the concept comprises weighting a rating obtained via the user higher than ratings obtained via the plurality of users.

12. The computer-implemented method of claim 9, further comprising providing a first rating tool to obtain the first rating and the second rating from the user and providing a second rating tool to obtain the third rating from the user.

13. The computer-implemented method of claim 12, wherein
the first rating tool comprises a first user interface which is configured to display each image from among the first set of images and the second set of images, the first user interface including user interface elements which are selectable to indicate whether an image from among the first set of images and the second set of images is a positive image corresponding to the concept or a negative image that does not correspond to the concept, and
the second rating tool comprises a second user interface which is configured to display each image from among the third set of images, the second user interface including information providing an explanation relating to the concept for the plurality of users and user interface elements which are selectable to indicate whether an image from among the third set of images is a positive image corresponding to the concept or a negative image that does not correspond to the concept.

14. The computer-implemented method of claim 1, wherein training the classifier model relating to the concept based on the first set of images rated by the user comprises:
implementing one or more pretrained models to train a neural network using image embeddings provided by the one or more pretrained models.

15. A computing system, comprising:
one or more processors; and
one or more non-transitory computer-readable media that store instructions that, when executed by the one or more processors, cause the computing system to perform operations, the operations comprising:
receiving an input from a user relating to a concept;
automatically obtaining a first set of images from an unlabeled dataset of images based on the input;
obtaining a first rating via the user for each image from the first set of images;
training a classifier model relating to the concept based on the first set of images rated by the user;
automatically obtaining a second set of images from the unlabeled dataset of images based on the classifier model trained based on the first set of images;
obtaining a second rating via the user for each image from the second set of images; and
retraining the classifier model relating to the concept based on the first set of images rated by the user and the second set of images rated by the user to obtain an updated classifier model.

16. The computing system of claim 15, wherein the input comprises a plurality of text phrases, the plurality of text phrases including at least one positive textual description relating to the concept and at least one negative textual description relating to the concept.

17. The computing system of claim 15, wherein
the classifier model is a binary classifier model, and
the first rating is a binary rating indicating whether an image from the first set of images is a positive image corresponding to the concept or a negative image that does not correspond to the concept.

18. The computing system of claim 15, further comprising:
automatically obtaining, by the computing system, a third set of images from the unlabeled dataset of images based on the updated classifier model trained based on the first set of images and the second set of images;
obtaining, by the computing system, a third rating via a plurality of users other than the user for each image from the third set of images; and
retraining, by the computing system, the updated classifier model relating to the concept based on the first set of images rated by the user, the second set of images rated by the user, and the third set of images rated by the plurality of users, to obtain a further updated classifier model.

19. The computing system of claim 18, wherein
a number of the third set of images is greater than a number of the first set of images and greater than a number of the second set of images, and
retraining the updated classifier model relating to the concept comprises weighting a rating obtained via the user higher than ratings obtained via the plurality of users.

20. One or more non-transitory computer-readable media that collectively store instructions that, when executed by one or more processors, cause the one or more processors to perform operations, the operations comprising:
receiving an input from a user relating to a concept;
automatically obtaining a first set of images from an unlabeled dataset of images based on the input;
obtaining a first rating via the user for each image from the first set of images;
training a classifier model relating to the concept based on the first set of images rated by the user;
automatically obtaining a second set of images from the unlabeled dataset of images based on the classifier model trained based on the first set of images;
obtaining a second rating via the user for each image from the second set of images; and
retraining the classifier model relating to the concept based on the first set of images rated by the user and the second set of images rated by the user to obtain an updated classifier model.
